(19) United States
(12) Patent Application Publication
(10) Pub. No.: US 2024/0407340 A1
(43) Pub. Date: Dec. 12, 2024

(54) TRACKING SYSTEMS WITH STANDARD TRANSMITTERS AND TAILORED CARRIERS

(71) Applicant: Marshall Radio Telemetry, Inc., North Salt Lake, UT (US)

(72) Inventors: Kevin Harcourt, Bountiful, UT (US); Jerry Merritt, Farmington, UT (US); Kevin Blake, West Valley City, UT (US)

(21) Appl. No.: 18/741,711

(22) Filed: Jun. 12, 2024

Related U.S. Application Data
(60) Provisional application No. 63/472,513, filed on Jun. 12, 2023.

(51) Int. Cl. A01K 35/00; A01K 29/00

(52) U.S. Cl. CPC A01K 35/00; A01K 29/005; A01K 2227/30

(57) ABSTRACT

A tracking system includes a standardized transmitter and a customizable carrier for the transmitter. The customizable carrier may have a configuration that enables it to be attached to and carried by a subject for long durations of time, while enabling the standardized transmitter to be used with a variety of different types or configurations of subjects. Methods of assembling tracking systems and methods of tracking subjects are also disclosed.

### CROSS-REFERENCE TO RELATED APPLICATION

A claim for the benefit of priority is hereby made to the Jun. 12, 2023 filing date of U.S. Provisional Patent Application No. 63/472,513, titled TRACKING SYSTEMS WITH STANDARD TRANSMITTERS AND TAILORED CARRIERS, the entire disclosure of which is hereby incorporated herein.

### TECHNICAL FIELD

This disclosure relates generally to tracking systems and tracking devices. More specifically, a tracking system of this disclosure includes a transmitter and a carrier, with the carrier being securable to a subject to be tracked and the transmitter being securable to the carrier. A method for tracking a subject may include selecting a carrier suitable for attachment to the subject, securing a transmitter to the carrier, and securing the carrier to the subject.

### RELATED ART

Tracking devices are used for a variety of purposes. As a few examples, tracking devices may be used to track objects, people, and animals. Various uses of tracking devices for animals include the use of a tracking device to provide information on the location of a person's pet and to provide information on the locations of wild animals in their natural habitats, or in the wild.

Conventionally, the housings of devices that track animals in the wild have been custom made, with design (e.g., size, shape, etc.) of a housing of a tracking device for use with a particular animal typically being tailored to be secured to and carried by that particular type of animal. The housings for such tracking devices may be manufactured with hand-laid composites, hand-assembling multiple custom cut/sized body panels, or using a three-dimensional (3D) printer. While these and other custom-manufacturing techniques and similar techniques have been the simplest way to offer a tailored solution for the end user, the manufacture of custom housings for tracking devices consumes significant time and resources and, thus, can be undesirably costly. In addition, custom-manufacturing techniques often result in housing designs that are sub-optimal, lack structural strength, are undesirably large, and/or have less refined looks and feels. Further, scaling up and producing large numbers of custom housings for bespoke animal tracking devices can be difficult and costly.

Although the housings of existing tracking devices are typically customized for use with a particular animal, the standard features of such housings, such as their bottom surfaces or mounting surfaces (i.e., the surfaces that are to be placed against the animal's body), are often not tailored to the shape of the body of the particular animal. Instead, the housings of tracking devices that are made to be worn by the bodies of animals in the wild are usually flat. The flat mounting surface of such a tracking device is the point of contact with the animal. Since the bodies of many animal species, for example, avian species, are often curved, a flat mounting surface may not transfer the weight of the tracking device evenly over the portion of the animals' body over which the tracking device is placed, instead causing pressure points or hot spots where extra force is applied to the animal's body. Pressure points and hot spots may cause discomfort, which may increase stress experienced by the animal.

### SUMMARY

A tracking system according to this disclosure may have a two-piece design. The two-piece design may include a carrier, which may be secured to a subject to be tracked (e.g., an animal, a human, an object, etc.), and a transmitter. The two-piece design may enable a single, standard transmitter or a small number of different configurations (e.g., sizes, shapes, etc.) of standard transmitters to be used with a plurality of different carriers that have been designed for use with a corresponding plurality of different types and/or sizes of subjects (e.g., animals, individuals, objects, etc.) to be tracked.

The transmitter may comprise any suitable transmitter that may be used to track a subject. The transmitter may be suitable for relatively short term tracking (e.g., days, weeks, etc.). Alternatively, the transmitter may be suitable for long-term tracking (e.g., months, years, etc.) of a subject. The transmitter may include electronics that enable it to employ one or more suitable tracking technologies (e.g., global positioning system (GPS), radio tracking, radio-frequency identification (RFID) tracking, geofencing, cellular triangulation, etc.), as well as one or more antennas, a power supply (e.g., a battery, a solar powered battery charger, etc.), and the like. In addition, the transmitter may include a housing, which may impart the transmitter with a standardized configuration (i.e., shape and size) (e.g., for a particular manufacturer, for a particular use, for an industry, etc.). In some embodiments, the transmitter may be designed for tracking a subject over a short period of time (e.g., hours, days, weeks, etc.). In other embodiments, the design of the transmitter may enable it to track a subject over a long period of time (e.g., months, years, etc.). Such a transmitter may be useful for wildlife tracking.

The carrier of the tracking system may include a carrier body. The carrier body may have a configuration (i.e., size, shape, weight, etc.) tailored for use with a particular type of subject (e.g., species of animal, etc.). The configuration of the carrier body may enable it to be securely and, as applicable, safely and comfortably carried by the subject. Without limitation, the carrier body may include a mounting surface that complements a contour of a surface of the type of subject on which the carrier will be placed. For example, a contour of the mounting surface may complement the contour of the surface of the type of subject. As another example, the mounting surface may space at least part of the carrier apart from the surface of the type of subject with which the carrier is to be used; by spacing at least part of the carrier apart from the surface, the carrier body may create an air gap between the subject and the transmitter and its inherent thermal mass, which may reduce thermal conductivity between the transmitter and the subject or even thermally isolate the transmitter from the subject.

The carrier body may include a receptacle that removably receives the transmitter. The receptacle may removably receive the transmitter. In some embodiments, upon assembly of the transmitter with the carrier body (e.g., introduction of the transmitter into the receptacle), the transmitter may snap or click into place. Additionally, one or more fasteners (e.g., screws, interlocking fasteners, touch fasteners, etc.) may secure the transmitter in place within the receptacle.

A mount of the carrier of the tracking system may be coupled to the carrier body and may be securable to a subject to be tracked. The mount may be designed for use with the type of subject to be tracked. In embodiments where the subject is an animal, the mount may comprise a harness, a collar, a strap, a clip, an adhesive, or the like. In embodiments where the subject is inanimate, the mount may be suitable for use with the subject (e.g., an adhesive, a magnet, etc.). The mount may hold the carrier in a particular orientation on the subject.

A method of tracking a subject may include selecting a carrier, assembling a transmitter with a carrier body of the carrier, and placing the carrier body on the subject. Selection of the carrier may include selecting a carrier that has been designed, or tailored, for use with a particular type (e.g., species of animal, type of object, etc.) of subject. Placement of the carrier may include placing a mounting surface of the carrier body on or over a corresponding surface of the subject. The mounting surface may have a contour complementary to a contour of the corresponding surface of the subject. The carrier body may space the mounting surface apart from the corresponding surface of the subject. The carrier may also be secured to the subject. For example, a mount coupled to the carrier body may secure the carrier to the subject. The mount may be designed, or tailored, to secure the carrier body to the particular type of subject.

The method may also include adjusting or modifying the carrier body of the tracking system to custom fit or adjust the fit of the carrier body to the subject. Such adjustments or modifications may be made before placing the carrier body on the subject. Alternatively, such adjustments or modifications may be made after the carrier body has been placed on the subject and, thus, they may be made after removing the carrier body from the subject; the carrier body may then be replaced on the subject. Thus, adjustments or modifications to the carrier body may be made in the field.

In a more specific embodiment, a method of tracking a subject may comprise tracking an animal. The animal may be tracked in the wild, such as in its natural habitat. In such an embodiment, the carrier may be tailored for use with the type of animal to be tracked (e.g., it may include a carrier body with mounting surface having a contour that complements a contour of a surface of the subject; it may include a carrier body that spaces a mounting surface apart from a surface of the subject; etc.). The transmitter may be assembled with the carrier and a carrier body of the carrier may be placed on and secured to an animal to be tracked. The animal may then be released, enabling it to freely move about in the wild (e.g., its natural habitat, etc.). Any adjustments or modifications to the carrier body may be made to occasionally ensure that the carrier body (and the transmitter) is properly positioned on the subject, to accommodate changes in the subject's body (e.g., growth, injury, etc.), or for any of a variety of other purposes.

Other aspects of the disclosed subject matter, as well as features and advantages of various aspects of the disclosed subject matter, should become apparent to those of ordinary skill in the art through consideration of the ensuing description, the accompanying drawings, and the appended claims.

### BRIEF DESCRIPTION OF THE DRAWINGS

In the drawings:

FIGS. 1 and 2 are perspective views of an embodiment of a transmitter of this disclosure;

FIG. 3 is a side view of the embodiment of the transmitter shown in FIG. 1;

FIG. 4 is a perspective view of a carrier that includes mounts that receive and hold the embodiment of transmitter shown in FIGS. 1-3;

FIG. 5 is a side view of the embodiment of the carrier shown in FIG. 4;

FIG. 6 is a top view of the embodiment of the carrier shown in FIG. 4;

FIG. 7 is a side view of an embodiment of a carrier with taller mounts than the embodiment of the carrier shown in FIGS. 4-6;

FIG. 8 is a side view of an embodiment of a carrier with even taller mounts than the embodiment of the carrier shown in FIG. 7;

FIG. 9 is a perspective view showing an embodiment of a tracking system that includes the embodiment of the transmitter shown in FIGS. 1-3 assembled with and carried by the embodiment of the carrier shown in FIGS. 4-6;

FIG. 10 is a side view of the tracking system shown in FIG. 9; and

FIG. 11 is a top view of the tracking system shown in FIG. 9.

### DETAILED DESCRIPTION

A tracking system of this disclosure includes a transmitter and a carrier. The transmitter may have a standardized design. The carrier, which may be tailored for use with a particular type of subject or even for use with a particular subject, receives the transmitter and secures the transmitter to the subject.

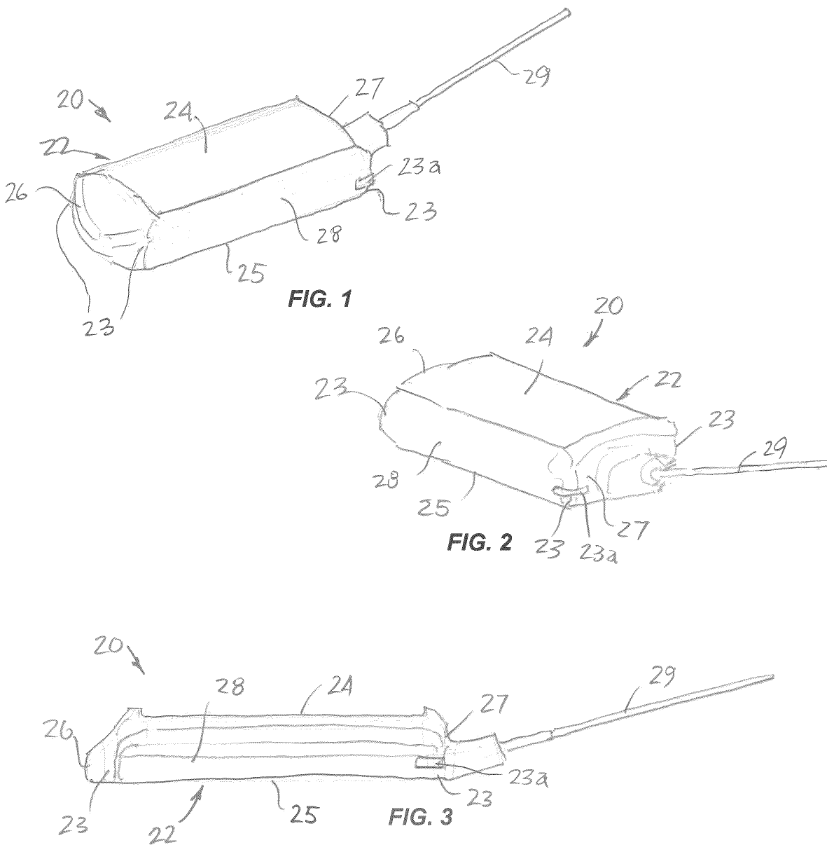

With reference to FIGS. 1-3, an embodiment of a transmitter 20 is illustrated. The transmitter 20 may comprise any suitable transmitter that may be used to track a subject. The transmitter 20 includes a housing 22 that carries electronics (not shown), a power supply (e.g., a battery, a solar powered battery charger, etc.) (not shown) and at least one antenna 29.

The housing 22 of the transmitter 20 may impart the transmitter 20 with a standardized configuration (i.e., shape and size) (e.g., for a particular manufacturer, for a particular use, for an industry, etc.). The housing 22 may include corners 23, as well as a top surface 24 and a bottom surface 25 and a bottom edge 26, a top edge 27, and side edges 28. The at least one antenna 29 may protrude from the top edge 27 of the housing 22.

The housing 22 of the transmitter 20 may provide an adequate seal (e.g., a hermetic seal, etc.) for the electronics and other components therein and be mechanically robust. These features may enable the transmitter 20 to withstand the environmental conditions to which the transmitter 20 will be exposed while the transmitter is carried by a subject for a prolonged duration of time. The material(s) from which the housing 22 is (are) constructed may provide an optimal strength-to-weight ratio. The material(s) from which the housing 22 is (are) constructed may be thermally conductive. Examples of suitable materials for the housing 22 include, without limitation, a metal, such as aluminum, titanium, or the like, or a metal alloy, such as a stainless steel or the like.

The electronics of the transmitter 20 may comprise a processing unit, a radio transmitter, and a GNSS navigation unit. The electronics and the associated antenna(s) 29 may enable the transmitter 20 to employ one or more suitable tracking technologies. As a few nonlimiting examples, the electronics and antenna(s) 29 may enable the transmitter 20 to employ global positioning system (GPS) tracking, radio tracking, radio-frequency identification (RFID) tracking, geofencing, cellular triangulation, or the like.

In some embodiments, the transmitter 20 may be designed to track a subject over a short period of time (e.g., hours, days, weeks, etc.). In other embodiments, the design of the transmitter 20 may enable it to track a subject over a long period of time (e.g., months, years, etc.). Such a transmitter 20 may be useful for wildlife tracking or for tracking any of a variety of different types of subjects.

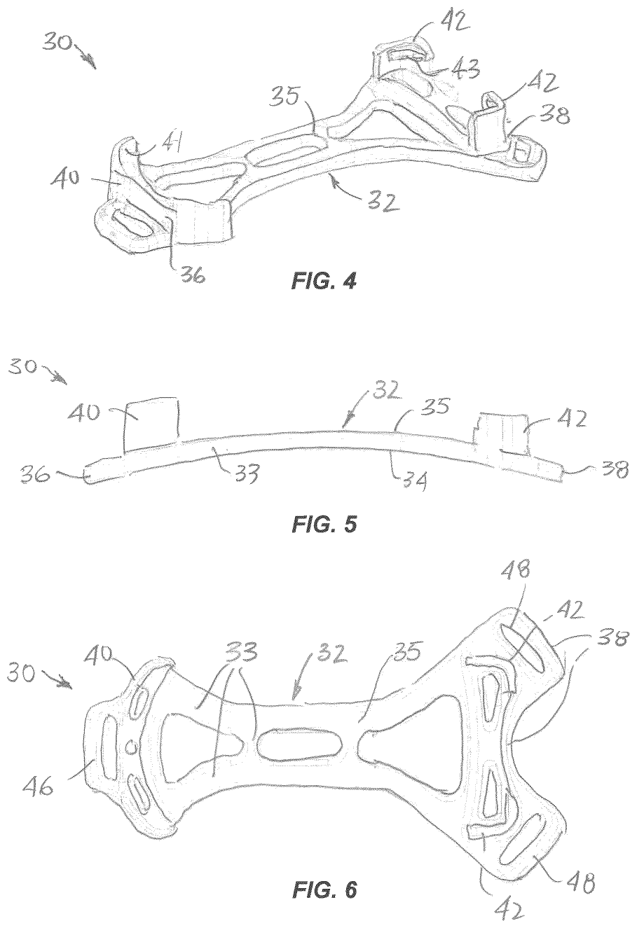

Turning now to FIGS. 4-6, an embodiment of a carrier 30 is illustrated. The carrier 30 is the element of a tracking system that mounts the transmitter 20 (FIGS. 1-3) to the subject to be tracked (e.g., to a body of the subject, etc.). A portion of the carrier 30 that interacts with the subject may be optimized for compatibility with (e.g., reduced wear on, comfort to, etc.) a surface of the subject against which the carrier 30 is to be placed.

In the embodiment of carrier 30 illustrated by FIGS. 4-6, the carrier 30 includes a frame 32, a bottom end 36, and a top end 38 opposite from the bottom end 36. The carrier 30 also includes a mount 40 protruding upwardly from the frame 32 at the bottom end 36 of the frame 32, as well as mounts 42 protruding upwardly from the frame 32 at the top end 38 of the frame 32. In addition, the carrier 30 includes an attachment feature 46 at the bottom end 36 of the frame 32 and attachment features 48 at the top end 38 of the frame 32.

The frame 32 of the mount 30 may include interconnected elongated members 33 that are arranged to provide openings to provide ventilation for a surface of a subject to which the mount 30 is attached.

The bottom surface 34 of the frame 32 of the carrier 30, which interacts with the subject, may be smooth and non-abrasive. As best seen in FIG. 5, the frame 32 of the mount 30 and/or a bottom surface 34 of the frame 32 may have a non-planar contour. A contour of the frame 32 and/or the bottom surface 34 may complement a contour of a surface of a subject on which the mount 30 may be placed. In the embodiment depicted by FIG. 5, the contour of the frame 32 and the bottom surface 34 is concave. The concave shape of the frame 32 and the bottom surface 34 may complement a contour of a surface of a body of an animal on which the mount 30 may be placed (e.g., the animal's back, the animal's neck, an appendage of the animal, etc.). In some embodiments, the bottom surface 34 of the frame 32 may conform to a shape of a surface of the subject against which the bottom surface 34 is to be placed. One or more of the foregoing configurations may enable the carrier 30 to be used on a subject for a long duration of time without detrimentally affecting the subject.

With continued reference to FIGS. 4-6, the mounts 40 and 42 may protrude from an upper surface 35 of the frame 32 of the carrier 30. The distance the mounts 40 protrude from the upper surface 35, or the height(s) of the mounts 40 and 42 may space a transmitter 20 a desired distance away from a surface of a subject on which the mount 30 may be placed. Such an arrangement may enable air to flow between the carrier 30 and a transmitter 20 (FIGS. 1-3) carried thereby, which may prevent heat from the transmitter 20 being transferred to a subject conducted to a subject to which the carrier 30 has been attached and may enhance cooling of the transmitter 20. In embodiments where the frame 32 and/or the bottom surface 34 of the frame 32 are/is contoured, the height(s) of the mounts 40 and 42 may account for the contour of the frame 32 and/or its bottom surface 34.

The mounts 40 and 42 are positioned to receive and engage corners 23 of the housing 22 of a transmitter 20, such as that illustrated by FIGS. 1-3. More specifically, each mount 40, 42 may include or define a recess 41, 43 that receives a one or more corners 23 of the housing 22 of the transmitter 20 or an engagement feature 23a (FIGS. 1-3) protruding from one or more corners 23 of the housing 22. Additionally, the mounts 40 and/or 42 may be rigid, but flexible enough to enable the housing 22 of the transmitter 20 to be snapped into place between the mounts 40 and 42 by way of an interference (press) fit and/or by elastic deformation of the mounts 40 and 42 (i.e., a click fit). Alternatively or additionally, an adhesive material, one or more fasteners, or the like may be used to secure the corners 23 of the housing 22 of the transmitter 20 in place relative to the mounts 40 and 42 of the carrier 30.

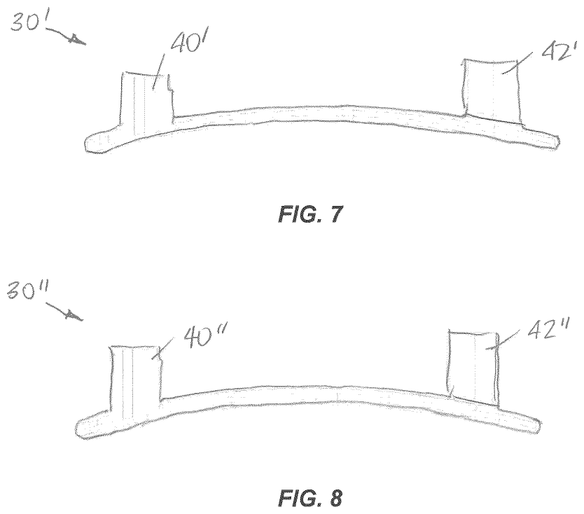

FIG. 7 depicts an embodiment of a carrier 30′ with mounts 40′ and 42′ that are taller than the mounts 40 and 42 of the embodiment of the carrier 30 shown in FIGS. 4-6. FIG. 8 depicts an embodiment of a carrier 30″ with mounts 40″ and 42″ that are taller than the mounts 40′ and 42′ of the embodiment of the carrier 30′ shown in FIG. 7.

With returned reference to FIGS. 4-6, attachment feature 46 may comprise a lateral extension of the bottom end 36 of the frame 32 and, thus, protrude laterally from the bottom end 36 of the frame 32. The attachment features 48 may similarly comprise lateral extensions of the top end 38 of the frame 32 and, thus, protrude laterally from the top end 38 of the frame 32. The attachment features 46 and 48 may comprise any suitable structure(s) that enable the carrier 30 to be secured to a subject. Without limitation, the attachment features 46 and 48 may comprise slots that receive straps or other elongated elements that may securely fasten the carrier 30 to a subject.

The carrier 30 may be formed from any suitable material. The material(s) from which the carrier 30 is formed may have low thermal conductivity. Such a material may prevent heat generated by a transmitter 20 carried by the carrier 30 from being conducted to a subject to which the carrier 30 has been attached. Without limitation, the carrier 30 may be formed from a plastic, such as a thermoplastic material. The carrier 30 may be manufactured relatively quickly and inexpensively in comparison to the housing of the transmitter 20. Thus, the carrier is readily customizable. Any of a variety of suitable processes may be used to manufacture the carrier 30, such as three-dimensional printing or other rapid prototyping or layered manufacturing processes or any other suitable process.

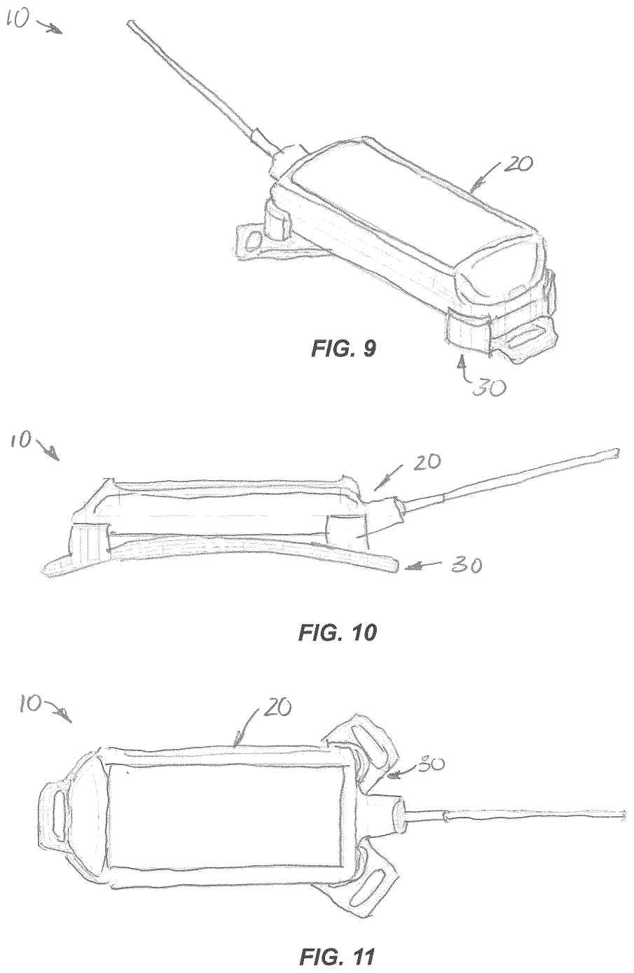

Looking now to FIGS. 9-11, an embodiment of a tracking system 10 is shown. The tracking system 10 includes a transmitter 20, such as that illustrated by FIGS. 1-3, and a carrier 30, such as that illustrated by FIGS. 4-6, the carrier 30′ depicted by FIG. 7, or the carrier 30″ depicted by FIG. 8. The transmitter 20 is assembled with and removably attached to the carrier 30.

A tracking system 10 with such a two-piece design allows for dynamic fitment of one type of transmitter 20 to be fitted to a variety of subjects (e.g., animals, such as multiple bird species, as well as various other types of animals; individuals; objects; etc.), different carrier 30 designs or configurations accommodating variations between different subjects. Stated another way, one configuration, or shape, of transmitter 20 housing 22 or a small number of configurations of transmitter 20 housings 22 may be used with a plurality of differently configured (e.g., customized, etc.) carriers 30. This aspect allows a single transmitter 20 design or a limited number of transmitter 20 designs to be used with a large number of relatively inexpensive carrier 30 designs or configurations, which may be tailored to for use with different subjects, enabling the transmitter 20 track any of a variety of different types of subjects with little or no modification to the transmitter 20 itself. Such a design may allow for streamlined transmitter 20 manufacturing processes, higher quality transmitters 20, and quicker response to new applications or uses of a transmitter 20.

For example, the carrier 30 may enable the height of the transmitter 20 (i.e., the distance of the transmitter 20 away from the subject's body) to be easily and independently adjusted for benefits like raising a transmitter 20 (e.g., to prevent solar panel coverage by feathers where the subject is a bird, etc.).

For avian species residing in geographies where temperatures or environmental conditions are extreme (e.g., Gyr Flacons in the Arctic, etc.), such species rely on the insulative layer of their feathers, which creates a thermal barrier known as a “feather gap” between the air trapped under the feathers and the surrounding environment. Prior transmitter designs have used an insulative pad (e.g., rubber, leather, or foam) as an additional piece to the design. Since the pads of such designs are placed on the birds' backs, they effectively eliminate the feather gap and its benefits. While the pads counteract the roughness of the bodies of prior transmitters, they may still cause chafing and disturb the birds, which may result in injury to the birds. Other prior designs have attempted to negate the issue of breaking the thermal barrier by constructing the entire transmitter housing out of a low thermal conductivity material (e.g., plastic, epoxy resin, or a composite material), which may compromise the strength and weight of the transmitter. The carrier 30 of a tracking system 10 of this disclosure may enable a transmitter 20 to be attached to an avian subject with minimal disruption of the natural thermal barrier of the feathers. For example, small mounts 40, 42 (e.g. three posts, four posts, etc.) of the carrier 30 may space the carrier 30 apart from the portion of the surface of the subject covered by the carrier 30 while minimizing contact between the carrier 30 and the surface of the subject, allowing for airflow over the feather layer of the covered portion of the surface of the subject's body.

A few optional features of the carrier and/or an assembly that includes a carrier and the transmitter are:
The carrier 30 preserves the natural air thermal barrier and air gap when mounted to feathered avian species.
A bottom surface 34 of the carrier 30 has a contour that complements, or matches, a contour of the animal's body (or back).
Modular design of the transmitter 20, where the housing 22 of the transmitter clicks into a standardized connector (e.g., then mounts 40 and 42) of the carrier 30.
Modular design of the transmitter 20, where the housing 22 is retained in the carrier 30 by one or more tabbed mounts 40, 42 and a single fastener (e.g., a screw, etc.).
Modular design of the transmitter 20, where the housing 22 attaches to the carrier 30 by means of one or more fasteners.
Modular design of the transmitter 20, where an end user may attach one or more specific carriers 30 to the housing 22 of the transmitter 20 to fit the transmitter 20 onto unique objects of interest.
Modular design of the transmitter 20, where the combination of the housing 22 and the carrier 30 creates a thermal barrier preventing heat conduction to or from the transmitter 20, electronics of the transmitter 20, and/or any solar panel on the transmitter 20 to the subject (e.g., a bird, etc.).
Modular design of the transmitter 20 and/or an upper portion of the carrier 30 that allows for the capture of the wearer's feathers, preventing obstruction of a solar panel on the top surface 24 of the housing 22.
Modular design of an attachment portion of the carrier 30 that allows for adjustable mounting height—to adjust spacing off the body of the subject in the field.

Although this disclosure provides many specifics, these should not be construed as limiting the scope of any of the claims that follow, but merely as providing illustrations of some embodiments of elements and features of the disclosed subject matter. Features from different embodiments may be employed in combination. Other embodiments of the disclosed subject matter, and of their elements and features, may be devised which do not depart from the spirit or scope of any of the claims. Accordingly, the scope of each claim is limited only by its plain language and the legal equivalents thereto.

What is claimed:

1. A tracking system, comprising:
a transmitter; and
a carrier including:
a carrier body with a receptacle that removably receives the transmitter; and
a mount coupled to the carrier body and securable to a subject to be tracked.

2. The tracking system of claim 1, wherein the carrier is designed for use with a particular type of subject to be tracked.

3. The tracking system of claim 2, wherein the transmitter has a configuration that enables it to be used with a plurality of different carriers designed for use with a plurality of different subjects to be tracked.

4. The tracking system of claim 1, wherein the subject to be tracked is an animal.

5. The tracking system of claim 1, wherein the animal is a bird.

6. The tracking system of claim 5, wherein the carrier body and the transmitter has shapes that prevent features of the bird from obstructing a solar panel of the transmitter.

7. The tracking system of claim 1, wherein the carrier body includes a mounting surface positionable against a surface of the subject to be tracked.

8. The tracking system of claim 7, wherein a shape of the mounting surface is tailored to be positioned on the surface of the subject to be tracked.

9. The tracking system of claim 7, wherein the carrier body spaces the mounting surface apart from the surface of the subject to be tracked.

10. The tracking system of claim 9, wherein the carrier body reduces thermal conductivity between the transmitter and the subject.

11. The tracking system of claim 9, wherein the carrier body thermally isolates the transmitter from the subject.

12. The tracking system of claim 1, wherein the transmitter snaps into the receptacle of the carrier body.

13. The tracking system of claim 12, wherein the carrier further comprises:
a fastener that further couples the transmitter to the carrier body.

14. The tracking system of claim 1, comprising a plurality of carriers of different configurations that enable the transmitter to be used with a corresponding plurality of different types of subjects.

15. A method of tracking an animal, comprising:
selecting a carrier tailored for use with a type of the animal;
assembling a transmitter with a carrier body of the carrier;
placing the carrier body on the animal, a mounting surface of the carrier body being placed on a corresponding surface of the animal;
securing the carrier to the animal with a mount coupled to the carrier body; and
releasing the animal.

16. The method of claim 15, wherein selecting the carrier comprises selecting a carrier with the carrier body having a mounting surface with a contour complementary to a contour of the corresponding surface of the type of the animal.

17. The method of claim 15, wherein selecting the carrier comprises selecting a carrier with the carrier body spaces the mounting surface apart from the corresponding surface of the type of the animal.

18. The method of claim 15, wherein releasing the animal comprises releasing the animal into its natural habitat.

19. The method of claim 15, further comprising:
custom fitting the carrier body to the animal.

20. The method of claim 19, wherein custom fitting the carrier body to the animal occurs before placing the carrier body on the animal.

21. The method of claim 19, wherein custom fitting the carrier body to the animal occurs after placing the carrier body on the animal and further comprising:
removing the carrier body from the animal;
adjusting or modifying the carrier body; and
replacing the carrier body on the animal.

22. A method of tracking a subject, comprising:
selecting a carrier tailored for use with a type of the subject;
assembling a transmitter with a carrier body of the carrier;
placing the carrier body on the subject, a mounting surface of the carrier body being placed on a corresponding surface of the subject; and
securing the carrier to the subject with a mount coupled to the carrier body.

23. The method of claim 22, wherein selecting the carrier comprises selecting a carrier with the carrier body having a mounting surface with a contour complementary to a contour of the corresponding surface of the subject.

24. The method of claim 22, wherein selecting the carrier comprises selecting a carrier with the carrier body spaces the mounting surface apart from the corresponding surface of the subject.
